(19) United States
(12) Patent Application Publication
(10) Pub. No.: US 2024/0302182 A1
(43) Pub. Date: Sep. 12, 2024

(54) MAPPING SYSTEM AND METHOD OF USING

(71) Applicant: NEC Corporation, Tokyo (JP)

(72) Inventors: Nagma Samreen KHAN, Tokyo (JP); Jiro ABE, Tokyo (JP); Kazumine OGURA, Tokyo (JP)

(21) Appl. No.: 18/180,861

(22) Filed: Mar. 9, 2023

(51) Int. Cl. G01C 21/00; G01C 21/32

(52) U.S. Cl. CPC G01C 21/3833; G01C 21/32; G01C 21/3867

(57) ABSTRACT

A mapping system includes a non-transitory computer readable medium configured to store instructions. The mapping system includes a processor connected to the non-transitory computer readable medium. The processor is configured to execute the instructions for receiving an input signal including image data of a scene; and determining a position of a sensor used to capture the image data relative to a reference map of the scene. The processor is configured to execute the instructions for determining a change point and a change score in the scene based on the determined position of the sensor and the reference map; and generating a change map based on the change point and the change score. The processor is configured to execute the instructions for generating an update map based on a comparison between the change map and the reference map; and maintaining a content of the reference map unchanged.

### BACKGROUND

A mapping system is usable to capture a scan or an image of a scene, such as a room, a factory, etc., and develop a three-dimensional (3D) map of the scene. The mapping system performs a subsequent scan or imaging of the scene and determines changes within the scene, such as movement of objects within the scene, new objects within the scene, or removal of objects within the scene. The mapping system then updates the 3D map based on the determined changes within the scene. The maps and updated maps generated by the mapping system are usable for a wide range of technologies including augmented reality (AR) gaming, virtual reality (VR) gaming, autonomous vehicle control, and other suitable activities.

### SUMMARY

An aspect of this description relates to a mapping system including a non-transitory computer readable medium configured to store instructions thereon. The mapping system further includes a processor connected to the non-transitory computer readable medium. The processor is configured to execute the instructions for receiving an input signal comprising image data of a scene. The processor is configured to execute the instructions for determining a position of a sensor used to capture the image data relative to a reference map of the scene. The processor is configured to execute the instructions for determining a change point and a change score for the scene based on the determined position of the sensor and the reference map. The processor is configured to execute the instructions for generating a change map based on the change point and the change score. The processor is configured to execute the instructions for generating an update map based on a comparison between the change map and the reference map. The processor is configured to execute the instructions for maintaining a content of the reference map unchanged.

An aspect of this description relates to a method of using a mapping system includes receiving an input signal comprising image data of a scene. The method includes determining a position of a sensor used to capture the image data relative to a reference map of the scene. The method includes determining a change point and a change score for the scene based on the determined position of the sensor and the reference map. The method includes generating a change map based on the change point and the change score. The method includes generating an update map based on a comparison between the change map and the reference map. The method includes maintaining a content of the reference map unchanged.

An aspect of this description relates to a non-transitory computer readable medium configured to store instructions thereon. The instructions are configured to cause a processor to receive an input signal comprising image data of a scene. The instructions are configured to cause a processor to determine a position of a sensor used to capture the image data relative to a reference map of the scene. The instructions are configured to cause a processor to determine a change point and a change score for the scene based on the determined position of the sensor and the reference map. The instructions are configured to cause a processor to generate a change map based on the change point and the change score. The instructions are configured to cause a processor to generate an update map based on a comparison between the change map and the reference map. The instructions are configured to cause a processor to maintain a content of the reference map unchanged.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a mapping system, in accordance with some embodiments.

FIG. 2 is a schematic view of a system for generating a reference map, in accordance with some embodiments.

FIG. 3 is a flowchart of a method of using a mapping system, in accordance with some embodiments.

FIG. 4 is a schematic view of a mapping system, in accordance with some embodiments.

FIG. 5 is a flowchart of a method of using a mapping system, in accordance with some embodiments.

FIG. 6 is a schematic view of a mapping system, in accordance with some embodiments.

FIG. 7 is a flowchart of a method of using a mapping system, in accordance with some embodiments.

FIG. 8 is a schematic view of a mapping system, in accordance with some embodiments.

FIG. 9 is a flowchart of a method of using a mapping system, in accordance with some embodiments.

FIG. 10 is a block diagram of a mapping system, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Mapping systems that directly update a map in order to determine changes from a previous image or scan of a scene have an increased risk of inaccurate determination of changes within the updated map. The increased risk of inaccuracies is due to several factors including quality of the imaging or scanning device; thresholding during registration of changes; failure to verify objects in the image or scan; or other such shortcomings. In order to reduce costs, lower resolution imaging or scanning devices are often used in mapping systems. These lower resolution devices increase a difficult in object identification and increase the risk that an object is detected under certain light conditions and is then not detected under different light conditions. Such a situation would cause the mapping system to consider the undetected object in the later image or scan as a change to the scene when the object is actually still present, but was just undetected. Thresholding is a technique used to reduce computational load on the mapping system. The thresholding is an attempt to account for slight differences within the scene due to light conditions, transient moving object (e.g., moving people), or other such situations. If the thresholding values are set too strict, then a risk of failing to identify a change within the scene increases. In contrast, if the thresholding values are set too loose, then a risk of false positives for changes within the scene increase. The failure to verify the geometry of objects within the scene increases a risk that a different object at a similar location as a previous object is treated as being the same object and no difference in the scene is identified.

In addition to the items that increase the risks of inaccuracies, the direct updating of the of map of the scene allows errors to propagate through successive iterations of the images or scans of the scene. For example, in a simultaneous localization and mapping (SLAM) technique, thresholding and assumptions are used during the analysis of an image or scan. The SLAM technique measures datapoints of the map one at a time in order to determine the location of objects within the scene. Any error in an earlier analysis will cause inaccuracies in subsequent analyses. The propagation of errors reduces the overall reliability of the maps generated by such mapping systems.

Mapping systems that produce higher quality maps that are less prone to inaccuracies are helpful in advancing automation of vehicle movement, increased realistic gaming environment, and other applications. In order to help improve map generation quality while avoiding the expense of continuous use of high-resolution imagers or scanners, a mapping system according to some embodiments of the current description utilize a reference map which remains unchanged during the operation of the mapping system. The utilization of the reference map provides a high quality fixed point of reference in order to reduce the risk of errors propagating through successive iterations of imaging or scanning of a scene. In addition, the mapping system according to some embodiments of the current description also utilizes object geometry verification to improve the precision of the mapping system relative to other approaches. As a result, the mapping system of some embodiments of the current description is able to utilize lower resolution imaging or scanning devices during implementation of the mapping system while still producing precise maps for uses in various applications.

For the sake of brevity, the following description will focus on images of a scene. One of ordinary skill in the art would recognize that images are merely exemplary and that other types of scene detection, such as point clouds, are within the scope of this description. The following description also refers to a sensor for capturing data related to the scene. In some embodiments, the sensor includes one or more camera, one or more thermal camera, one or more video camera, one or more light and range detector (LiDAR), combinations of these elements, or another suitable sensor.

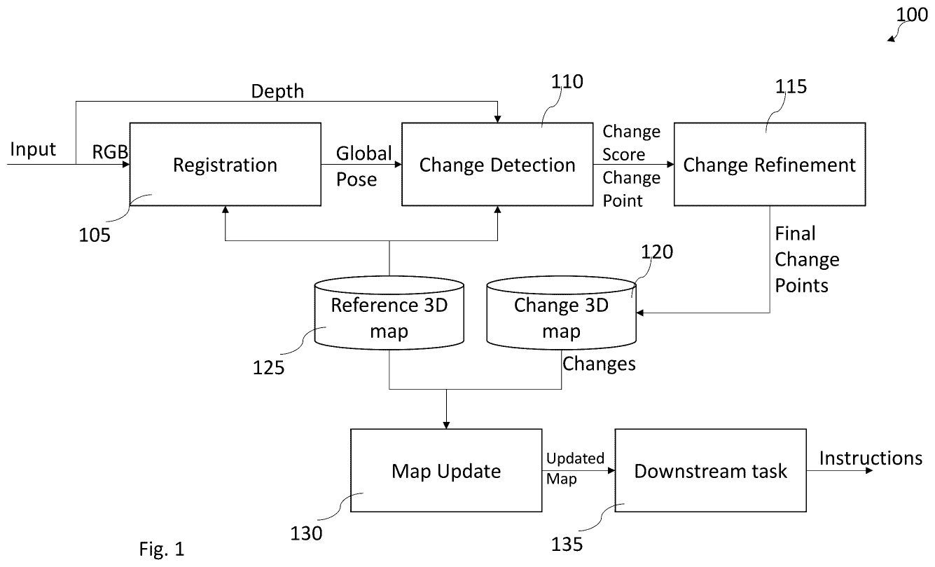

FIG. 1 is a schematic view of a mapping system 100, in accordance with some embodiments. The mapping system 100 is configured to receive an input signal. The input signal includes both image and depth data. In some embodiments, the image data includes red, green blue (RGB) image data. In some embodiments, the image data includes another type of image data, such as greyscale, thermal, or another suitable type of image data. The mapping system 100 includes a registration module 105 configured to receive the image data from the input signal and a reference three-dimensional (3D) map 125. The registration module 105 is configured to generate a global pose which indicates a location of a sensor used to collect the input signal relative to the reference 3D map 125. The mapping system 100 further includes a change detection module 110 configured to receive depth data from the input signal, the global pose from the registration module 105 and the reference 3D map 125. The change detection module 110 is configured to generate a change score and a change point for each object within the scene. The mapping system 100 further includes a change refinement module 115 configured to receive the change score and change point from the change detection module 110. The change refinement module 115 is configured to perform post processing to determine whether an object within the scene has changed relative to a previous iteration of the mapping of the scene. The mapping system 100 further includes a change 3D map 120 configured to receive final change points from the change refinement module 115. The change 3D map 120 stores information related to changes within the scene based on the input signal relative to the reference 3D map 125. The mapping system 100 avoid updating the reference 3D map in order to help reduce propagation of errors through successive iterations of mapping of the scene. The mapping system 100 further includes a map update module 130 configured to combine the reference 3D map 125 with the change map 120 in order to determine an updated map of the scene. The mapping system 100 further includes a downstream task module 135 configured to generate a decision or instructions based on the received updated map from the map update module 130.

The input signal includes both image data to capture texture/color properties within the scene as well as depth data to facilitate detection of relative position of points within the scene. In some embodiments, the image data includes color image data. In some embodiments, the image data includes greyscale data. The current description focuses on color image data; however, one of ordinary skill in the art would recognize that the current application is not limited to color image data. In some embodiments, the input signal is received from a single sensor including both image and depth detection capabilities. In some embodiments, the input signal is received from more the one sensor. In some embodiments, the multiple sensors include a same type of sensor, e.g., image detecting sensors. In some embodiments, the multiple sensors include different types of sensors, e.g., a LiDAR sensor and an image detecting sensor. In some embodiments, the depth data is generated based on stereo image sensing by using triangulation. In some embodiments, the depth data is generated using a structured light sensor. In some embodiments, the depth data is generated using a time of flight (ToF) sensor.

In some embodiments, the input signal is broken down into frames in order to assist with the processing load on the mapping system 100. A frame is a smaller portion of the scene. All of the frames for the input signal are captured at a same time, which is after the creation of the reference 3D map 125. The mapping system 100 analyzes each of the frames separately to determine change points and change scores, as described below. Identification of geometrically meaning objects within the input signal is performed utilizing multiple the frames in order to help increase precision of the determination of geometrically meaningful objects. In some embodiments, all of the frames are analyzed during determination of geometrically meaningful objects. In some embodiments, once enough frames are analyzed that a geometrically meaningful object is identified, analysis of the frames relative to the identified geometrically meaningful object.

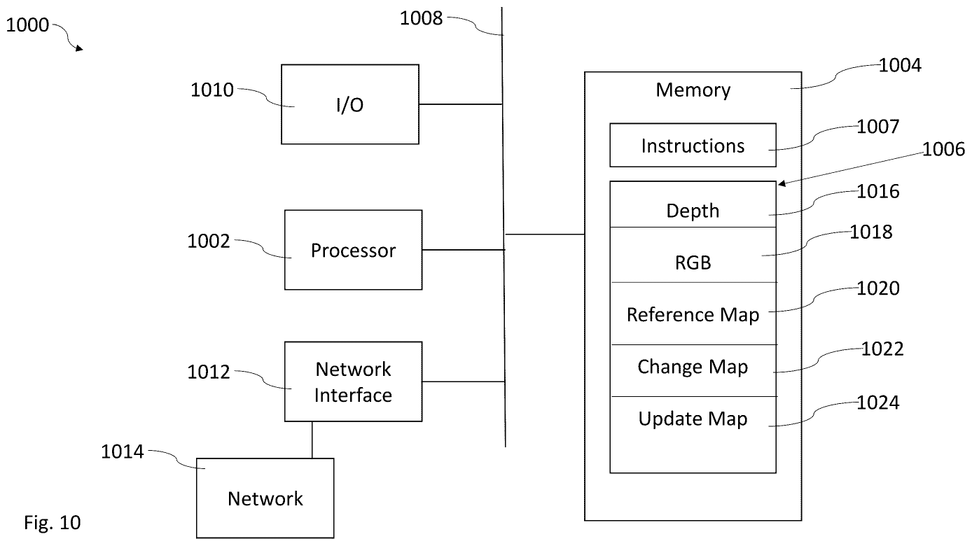

The registration module 105 is configured to receive the reference 3D map 125 and the image data from the input signal. The registration module 105 is configured to determine a position of the sensor used to capture the image data. The registration module 105 is configured to output the global pose based on the determined position of the sensor relative to the reference 3D map 125. The global pose includes the image data as well as the location of the sensor. By using the image data without consideration of the depth data, a processing load on the registration module 105 is reduced relative to a system that generates a global pose using an entirety of the input signal. In some embodiments including multiple sensors, the registration module 105 is configured to determine the position of each of the sensors used to capture the input signal. The registration module 105 utilizes permanent objects or points within the reference 3D map 125 to determine the position of the sensor. The registration module 105 is implemented using one or more processors, such as the processor discussed with respect to a mapping system 1000 (FIG. 10), below.

The change detection module 110 is configured to receive the reference 3D map 125, the global pose from the registration module 105, and the depth data from the input signal. The change detection module 110 is configured to compare the information in the reference 3D map 125 with the data from the global pose and the depth data to determine whether changes have occurred in the scene relative to the reference 3D map 125. The determination of changes by the change detection module 110 are relative to the reference 3D map 125, not relative to a previous iteration of mapping the scene by the mapping system 100. The change detection module 110 is configured to identify a region of the 3D reference map 125 that corresponds to the frame currently under analysis based on the global pose. The change detection module 110 is further configured to identify points within the scene and the location of detected points within the scene using the depth or point-to-point distance data. In some embodiments, the change detection module 110 is configured to identify objects within the scene and the location of the detected objects based on the depth or point-to-point distance data. The change detection module 110 is configured to compare the identified point(s) and the location of the identified point(s) with the reference 3D map 125 to determine whether any identified points that have been added to the scene or moved within the scene. The change detection module 110 is also configured to determine whether any points from the reference 3D map 125 have been removed from the scene since the generation of the reference 3D map 125 based on the global pose and depth data. The change detection module 110 is configured to generate a change point indicating a location of an identified change and a change score indicating a likelihood of the identified change. In some embodiments, the change detection module 110 is further configured to generate a change point indicating the color in addition to the location of a detected change if color image data is available. One of ordinary skill in the art would recognize that a change point indicating greyscale is also possible if greyscale image data is available.

A change point indicates a location within the scene that is different from the same location within the reference 3D map 125. The change score indicates how likely the change point is to be an actual change. That is, the change point indicates that some type of change has occurred at a location within the scene; and the change score indicates how likely the identified change is to be an actual change in the scene rather than an artifact generated by different light conditions or other factors that impact the precision of object detection. The following discussion provides an example for clarifying change points and change scores. One of ordinary skill in the art would understand that the mapping system 100 is not limited to the example discussed below.

In at least one example, the reference 3D map 125 includes a table with no object located on the table. The input signal includes an image of the scene including a box located on the table. Utilizing the depth data, the change detection module 110 is able to determine that locations within the scene have changed. For example, a distance between a closest object in the reference 3D map 125, e.g., a wall in a rear of the scene, and the input signal, i.e., the box, is different. The change detection module 110 indicates a change point based on the difference in the depth data between the reference 3D map 125 and the input signal. The change detection module 110 then generates a change score for each point where a change was found. The generation of the change score helps to reduce false positives for identified change points. The change score for a top of the box will be large because a distance between the rear wall of the scene and the top of the box has a large magnitude. In contrast, the change score for the bottom of the box will be small because a distance between the top surface of the table and the bottom of the box has a small magnitude. The combination of the change point and the change score helps the change refinement module 115 to determine the boundary of detected points of potential change within the input signal, as discussed below.

The change detection module 110 is implemented using one or more processors, such as the processor discussed with respect to the mapping system 1000 (FIG. 10), below. In some embodiments, the change detection module 110 is implemented using a same processor as the registration module 105. In some embodiments, the change detection module 110 is implemented using a different processor from the registration module 105.

The change refinement module 115 is configured to receive the change point and change score data from the change detection module 110. The change refinement module 115 is further configured to receive the image data. The change refinement module 115 is configured to perform geometric analysis of the change point and change score data to refine a determination of boundaries of the object associated with the change point and change score data. In some embodiment, the change refinement module 115 is further configured to receive the reference 3D map 125 or assist in the refinement of boundaries of the object.

Returning to the non-limiting example of a box on a table from above, the change refinement module 115 is configured to help determine the boundaries of the box. As discussed above, the change scores at the bottom of the box are small. In a system that merely performs thresholding to determine that a change score below a certain value is not a change, a risk of a “floating object” increases. That is, the top of the box would show up as a change, but the bottom of the box would not show up as a change. The result would be that the top of the box appears to be floating over the table in the map update of the scene. However, the change refinement module 115 is configured to determine whether a geometry of the change point and change score data generates a meaningful shape for addition to the map of the scene. To make such a determination, the change refinement module 115 is configured to utilize the change score for neighboring change points to help determine whether a geometrically meaningful object is represented by the change point and change score data. A geometrically meaningful object includes an object that has defined boundaries and that has a spatial relationship with other objects that makes physical sense. For example, a “floating object” does not make physical sense, while an object sitting on a table does make physical sense. Geometrically meaningful objects are built from one or more geometrically meaningful shapes. In some embodiments, a single object includes multiple geometrically meaningful shapes. For example, a bicycle includes multiple circles as well as at least one rectangle, in some instances.

Continuing with the non-limiting example of a box on a table, the change refinement module 115 is configured to determine that the change scores at the top of the box indicate that an object is highly likely to be present. The change refinement module 115 is configured to adjust the thresholds for nearby change points, e.g., the bottom of the box, to attempt to identify a geometrically meaningful object. The change refinement module 115 is configured to either indicate a change associated with an entirety of the geometrically meaningful object or to reject an entirety of a potential object in response to a failure to determine a geometrically meaningful object. One of ordinary skill in the art would understand indicating a change includes adding the object, moving the object within the scene, or removing the object from the scene. By implementing changes for an entirety of an object, a risk of errors when updating the 3D map decreases; and the updated 3D map is more likely to resemble a realistic scene, such as no “floating objects.” The change refinement module 115 is configured to analyze the change points to estimate object boundaries, for example, using clustering or segmentation. The change refinement module 115 is then able to utilize change points deemed to be potentially within the estimated object boundaries to determine whether a geometrically meaningful object is detected. In some embodiments, the change refinement module 115 is configured to utilize an average of all change scores within the estimated boundary of a potential object to determine whether to determine the object is a change. In some embodiments, the change refinement module 115 is configured to determine whether a threshold percentage of change points within the estimated boundary of the potential object have a change score above a threshold score to determine whether the object is a change. In some embodiments, a user is able to select an algorithm for use by the change refinement module 115 based on the sensor used to capture the input signal. For example, in some embodiments, the use of the percentage of change points being above a threshold change score is more likely to produce accurate results when the sensor generates a noisy input signal in comparison with the average change score algorithm.

The change refinement module 115 is implemented using one or more processors, such as the processor discussed with respect to the mapping system 1000 (FIG. 10), below. In some embodiments, the change refinement module 115 is implemented using a same processor as the registration module 105 and the change detection module 110. In some embodiments, the change refinement module 115 is implemented using a different processor from the registration module 105 or the change detection module 110.

The change 3D map 120 is generated based on final change points received from the change refinement module 115. The final change points indicate a location of changes for entire objects within the scene. In some embodiments, the changes indicate addition of an object, removal of an object, or movement of an object within the scene. In some embodiments, the change 3D map 120 includes the image data along with the final change points to determine the changes to the 3D map relative to the reference 3D map 125. The change 3D map 120 is stored in a non-transitory computer readable medium, such as a memory in the mapping system 1000 (FIG. 10), discussed below.

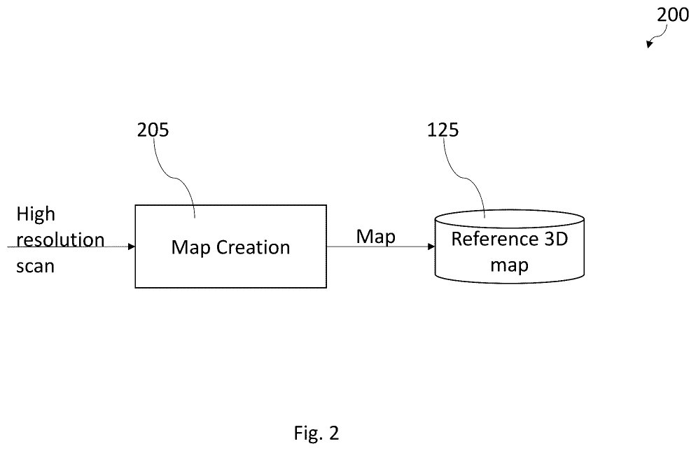

The reference 3D map 125 includes a map generated using a high resolution sensor to capture the scene. In some embodiments, the reference 3D map 125 includes dimensions of objects within the scene. In some embodiments, the dimensions in the reference 3D map 125 are scaled dimensions of true dimensions of objects within the scene. In some embodiments, the reference 3D map 125 is generated using the system 200 (FIG. 2), discussed below. The reference 3D map 125 remains constant during the use of the mapping system 100. The reference 3D map 125 is usable to as a stable basis for comparison during use of the mapping system 100 in order to help prevent or reduce the propagation of errors during subsequent iterations of mapping the scene using the mapping system 100. The reference 3D map 125 is stored in a non-transitory computer readable medium, such as a memory in the mapping system 1000 (FIG. 10), discussed below. In some embodiments, the reference 3D map 125 is stored in a same non-transitory computer readable medium as the change 3D map 120. In some embodiments, the reference 3D map 125 is stored in a different non-transitory computer readable medium from the change 3D map 120.

The map update module 130 is configured to combine the changes from the change 3D map 120 with the reference 3D map 125 in order to generate an updated map. The updated map includes changes to entire objects identified by the change refinement module 115. In some embodiments, the updated map is stored in a non-transitory computer readable medium, such as a memory in the mapping system 1000 (FIG. 10), discussed below. In some embodiments, the updated map is stored in a same non-transitory computer readable medium as the change 3D map 120 and the reference 3D map 125. In some embodiments, the change map is stored in a different non-transitory computer readable medium from the change 3D map 120 or the reference 3D map 125.

The downstream task module 135 is configured to implement instructions based on the received change map. The following discussion utilizes a non-limiting example of autonomous vehicle control. One of ordinary skill in the art would understand that the current description is not limited to this example. For example, in some embodiments, the downstream task module 135 utilizes the updated map to instruct a vehicle, e.g., a vehicle in a factory, to navigate around a newly added object, e.g., a pallet of materials, within the scene. In some embodiments, the downstream task module 135 is configured to transmit the instructions directly to the vehicle. In some embodiments, the downstream task module 135 is configured to provide the instructions to an external device usable for controlling the vehicle. In some embodiments, the instructions are transmitted wirelessly. In some embodiments, the instructions are transmitted via a wired connection.

The downstream task module 135 is implemented using one or more processors, such as the processor discussed with respect to the mapping system 1000 (FIG. 10), below. In some embodiments, the downstream task module 135 is implemented using a same processor as the registration module 105, the change detection module 110 and the change refinement module 115. In some embodiments, the downstream task module 135 is implemented using a different processor from the registration module 105, the change detection module 110, or the change refinement module 115.

Utilizing the mapping system 100, an updated map is able to be generated that has a higher precision in comparison with other approaches due to the change determination being performed for entire objects. In addition, maintaining the reference 3D map 125 in an original state during the mapping of the scene helps to reduce or prevent propagation of errors through multiple scene mapping iterations. As a result, instructions provided to external devices based on the updated map are more precise than instructions using maps generated using other systems.

FIG. 2 is a schematic view of a system 200 for generating a reference map, in accordance with some embodiments. The system 200 is usable to create a reference 3D map 125. In some embodiments, the system 200 is usable to create the reference 3D map 125 usable by the mapping system 100 (FIG. 1). In some embodiments, the system 200 is usable to create the reference 3D map 125 usable in a different mapping system from the mapping system 100 (FIG. 1). The system 200 includes a map creation module 205 configured to receive a high resolution scan of a scene. The map creation module 205 is configured to generate a map which is stored as the reference 3D map 125.

The high resolution scan is performed using at least one high resolution sensor configured to capture both image data and depth data related to a scene. In some embodiments, the high resolution scan is performed using a sensor having a higher resolution than that used to capture the input signal for the mapping system 100 (FIG. 1). In some embodiments, the high resolution scan is performed at multiple locations relative to the scene in order to help ensure accuracy and precision of the reference 3D map 125. In some embodiments, the high resolution scan is performed using a single sensor including both image and depth detection capabilities. In some embodiments, the high resolution scan is performed using more than one sensor. In some embodiments, the multiple sensors include a same type of sensor, e.g., image detecting sensors. In some embodiments, the multiple sensors include different types of sensors, e.g., a LiDAR sensor and an image detecting sensor. In some embodiments, the depth data is generated based on stereo image sensing by using triangulation. In some embodiments, the depth data is generated using a structured light sensor. In some embodiments, the depth data is generated using a ToF sensor. In some embodiments, the high resolution scan is performed using multiple sensors configured to receive a same type of information, e.g., image data or depth data, to help ensure accuracy and precision of the reference 3D map 125.

The map creation module 205 is configured to receive the high resolution scan and generate a map. The map creation module 205 is configured to perform object identification to identify objects within the scene. The map creation module 205 is configured to utilize the depth data to determine the placement of the identified objects in the scene relative to one another. In some embodiments, the map create module 205 is configured to perform object recognition, e.g., using a trained neural network, in order to identify permanent objects and movable objects within the scene. In some embodiments, the trained neural network includes a database of object types likely to occur within the scene. In some embodiments, the map creation module 205 is configured to generate the map including meta data indicating whether an identified object is a permanent object or a moveable object. The map creation module 205 is configured to instruct the map to be stored in a non-transitory computer readable medium as the reference 3D map 125.

The map creation module 205 is implemented using one or more processors, such as the processor discussed with respect to the mapping system 1000 (FIG. 10), below. In some embodiments, map creation module 205 is implemented using a same processor as each of the modules in the mapping system 100 (FIG. 1). In some embodiments, the map creation module 205 is implemented using a different processor from at least one of the modules in the mapping system 100 (FIG. 1).

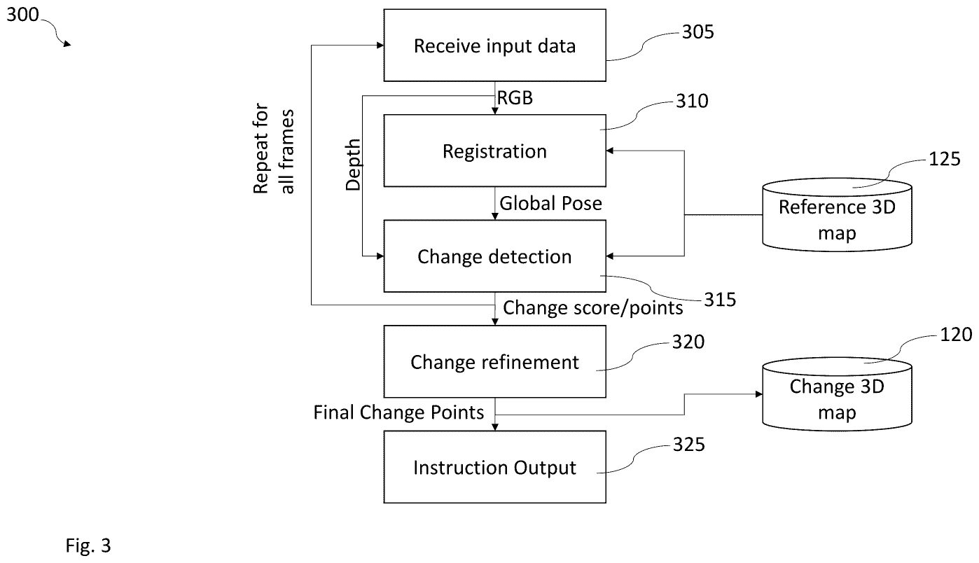

FIG. 3 is a flowchart of a method 300 of using a mapping system, in accordance with some embodiments. The method 300 is implemented by a mapping system to generate a change map and to generate instructions for a downstream implementation. In some embodiments, the method 300 is implemented using the mapping system 100 (FIG. 1). In some embodiments, the method 300 is implemented using a mapping system other than the mapping system 100 (FIG. 1).

In operation 305, input data is received by the mapping system. The input data includes both image data to allow object detection within the scene as well as depth data to facilitate detection of relative position of points within the scene. In some embodiments, the image data includes color image data. In some embodiments, the image data includes greyscale data. The current description focuses on color image data; however, one of ordinary skill in the art would recognize that the current application is not limited to color image data. In some embodiments, the input data is received from a single sensor including both image and depth detection capabilities. In some embodiments, the input data is received from more the one sensor. In some embodiments, the multiple sensors include a same type of sensor, e.g., image detecting sensors. In some embodiments, the multiple sensors include different types of sensors, e.g., a LiDAR sensor and an image detecting sensor. In some embodiments, the depth data is generated based on stereo image sensing by using triangulation. In some embodiments, the depth data is generated using a structured light sensor. In some embodiments, the depth data is generated using a ToF sensor.

In operation 310, registration of the image data from the input data is performed. The registration is performed based on the image data and the reference 3D map 125. In some embodiments, the registration is performed using the registration module 105 (FIG. 1). In some embodiments, the registration is performed using a different device from the registration module 105 (FIG. 1). The registration determines a position of the sensor used to capture the image data. The registration outputs a global pose based on the determined position of the sensor with respect to the 3D reference map 125. The global pose includes the image data as well as the location of the sensor. By using the image data without consideration of the depth data, a processing load during the registration is reduced relative to a method that generates a global pose using an entirety of the input signal. In some embodiments including multiple sensors, the registration determines the position of each of the sensors used to capture the input signal. The registration utilizes permanent objects within the reference 3D map 125 to determine the position of the sensor.

In operation 315, a change detection is performed using the global pose and the depth data from the input data. The change detection is performed by comparing the reference 3D map 125 with the depth data. In some embodiments, the change detection is performed using the change detection module 110 (FIG. 1). In some embodiments, the change detection is performed using a different device from the change detection module 110 (FIG. 1). The change detection compares the information in the reference 3D map 125 with the data from the global pose and the depth data to determine whether changes have occurred in the scene relative to the reference 3D map 125. The determination of changes is relative to the reference 3D map 125, not relative to a previous iteration of mapping the scene. The change detection compares the identified region of the 3D reference map 125 that corresponds to the frame currently under analysis based on the global pose. The change detection further identifies points within the scene and the location of detected points within the scene using the depth data or point-to-point distance data. In some embodiments, the change detection identifies points within the scene and the location of the detected points based on the depth data. The change detection also determines whether any points from the reference 3D map 125 have been removed from the scene since the generation of the reference 3D map 125 based on the global pose and depth data. The change detection generates a change point indicating a location of an identified change and a change score indicating a likelihood of the identified change. In some embodiments, the change detection includes generating a change point indicating the color in addition to the location of a detected change if color image data is available. One of ordinary skill in the art would recognize that a change point indicating greyscale is also possible if greyscale image data is available.

Following operation 315, the operations 305 through 315 are repeated until all frames of the input data are analyzed to determine whether any changes have occurred within the scene. In some embodiments, the input data is broken down into frames or sections of the entire scene in order to reduce processing load for performing registration and change detection. Each of the frames are captured at a same time. In some embodiments where multiple sensors are used to capture the input data, analysis of all of the frames includes analysis of the input data from all of the sensors.

In operation 320, change refinement is performed using the change points and change scores from the change detection in operation 315. The change refinement helps to ensure that entire objects are considered when evaluating potential changes within the scene. In some embodiments, the change refinement is performed using the change refinement module 115 (FIG. 1). In some embodiments, the change refinement is performed using a device other than the change refinement module 115 (FIG. 1). The change refinement helps determine the boundaries of the identified objects. The change refinement determines whether a geometry of the change point and change score data generates a meaningful shape for addition to the map of the scene. To make such a determination, the change refinement utilizes the change score for neighboring change points to help determine whether a geometrically meaningful object is represented by the change point and change score data. The change refinement analyzes the change points to estimate object boundaries, for example, using clustering or segmentation. In some embodiments, the change refinement utilizes an average of all change scores deemed to be potentially within the estimated object boundaries of a potential object to determine whether to determine the object is a change. In some embodiments, the change refinement determines whether a threshold percentage of change points within the estimated object boundaries of the potential object have a change score above a threshold score to determine whether the object is a change. In some embodiments, a user is able to select an algorithm for implementing the change refinement based on the sensor used to capture the input signal. For example, in some embodiments, the use of the percentage of change points being above a threshold change score is more likely to produce accurate results when the sensor generates a noisy input signal in comparison with the average change score algorithm.

The change refinement of operation 320 outputs final change points, which are stored in a change 3D map 120. The change 3D map 120 and the reference 3D map 125 are similar to the change 3D map 120 and the reference 3D map 125 discussed above and the details are not discussed here for the sake of brevity.

In operation 325, instructions are output based on the final change points determined by the change refinement 320. The instructions are generated based on an updated map formed based on a comparison between the change 3D map 120 and the reference 3D map 125. In some embodiments, the updated map is stored in a non-transitory computer readable medium, such as a memory in the mapping system 1000 (FIG. 10), discussed below. In some embodiments, the instructions are output using the downstream task module 135 (FIG. 1). In some embodiments, the instructions are output using a device other than the downstream task module 135 (FIG. 1). In some embodiments, the instructions are transmitted directly to an external device, e.g., a vehicle, for controlling the external device based on the updated map. In some embodiments, the instructions are provided to an external controller usable for controlling the external device. In some embodiments, the instructions are transmitted wirelessly. In some embodiments, the instructions are transmitted via a wired connection.

One of ordinary skill in the art would recognize that the method 300 is capable of being adjusted. In some embodiments, at least one operation is added to the method 300. For example, in some embodiments, the method 300 further includes an updated map generating operation. In some embodiments, at least one operation is omitted from the method 300. For example, in some embodiments, the operation 325 is omitted and the change 3D map 120 is stored on the non-transitory computer readable medium for use by a separate method. In some embodiments, an order of operations of the method 300 is adjusted. For example, in some embodiments, the operation 320 is included as part of the repeating operations for each of the frames.

Utilizing the method 300, the change 3D map 120 has a higher precision in comparison with other approaches due to the change determination being performed for entire objects. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

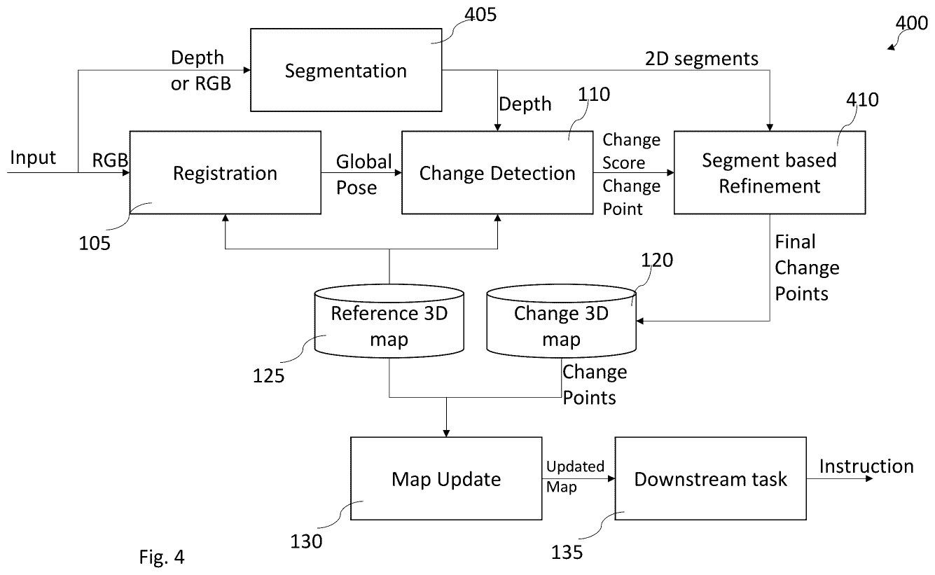

FIG. 4 is a schematic view of a mapping system 400, in accordance with some embodiments. The mapping system 400 includes similar elements as the mapping system 100 (FIG. 1). Elements having the same reference number in the mapping system 400 are similar as elements having the corresponding reference number in the mapping system 100 (FIG. 1). Discussion of the elements having the same reference number is truncated for the sake of brevity.

In comparison with the mapping system 100 (FIG. 1), the mapping system 400 includes a segmentation module 405 configured to receive both image data and depth data from the input signal. The segmentation module 405 is configured to output two-dimensional (2D) segments to the segment based refinement module 410. Additionally, the segmentation module 405 is configured to output depth data to the change detection module 110. In some embodiments, the change detection module 110 is configured to directly receive the depth data from the input signal without the input signal passing through the segmentation module 405. The segment based refinement module 410 is configured to receive the 2D segments from the segmentation module 405 as well as the change points and change scores from the change detection module 110. The segment based refinement module 410 is configured to output the final change points to the change 3D map 120.

The segmentation module 405 is configured to analyze the input signal, including either only depth data or both image data and depth data, to identify objects in the scene. The segmentation module 405 utilizes an algorithm to classify pixels in the input signal to help identify boundaries of objects within the scene. In some embodiments, the segmentation module 405 utilizes a k-means clustering algorithm, fuzzy c-means clustering (FCM) algorithm, neural networks or another suitable algorithm. The segmentation module 405 identifies the boundaries of the objects and outputs 2D segments that are usable by the segment based refinement to improve accuracy of change determination within the scene. The 2D segments include boundaries of objects identified by the segmentation module 405. In some embodiments, the segmentation module 405 is configured to generate 3D segments; however, the generation of 3D segments utilizes more processing load than the generation of 2D segments.

The segmentation module 405 helps to improve object identification in the mapping system 400 in comparison with other approaches that do not include image segmentation. However, the segmentation module 405 increases a processing load on the mapping system 400 in comparison with other approaches that do not include image segmentation. The segmentation module 405 is implemented using one or more processors, such as the processor discussed with respect to the mapping system 1000 (FIG. 10), below. In some embodiments, the segmentation module 405 is implemented using a same processor as the registration module 105, the change detection module 110, the segment based refinement module 410 and the downstream task module 135. In some embodiments, the segmentation module 405 is implemented using a different processor from the registration module 105, the change detection module 110, the segment based refinement module 410, or the downstream task module 135.

The segment based refinement module 410 is configured to receive the 2D segments from the segmentation module 405 and the change points and change scores from the change detection module 110. The segment based refinement module 410 functions in a similar manner to the change refinement module 115 (FIG. 1), discussed above. Similar to the change refinement module 115 (FIG. 1), the segment based refinement module 410 analyzes the received data to identify geometrically meaningful objects within the scene for determination of changes within the scene. In comparison with the change refinement module 115 (FIG. 1), the segment based refinement module 410 is able to compare the change points and change scores with the 2D segments in order to improve the accuracy of change determination. Returning to the non-limiting example of the box on the table discussed above, the 2D segments are useful for more precisely identifying the bottom of the box than relying solely on the change scores as discussed above with respect to the change refinement module 115 (FIG. 1). The 2D segments would provide data related to the determined location of the bottom of the box in order to assist in the determination of whether the box is a geometrically meaningful object usable to indicate a change in the scene. The segment based refinement module 410 outputs final change points to the change 3D map 120 following determination of whether one or more change is present in the scene based on the input signal.

The segment based refinement module 410 is implemented using one or more processors, such as the processor discussed with respect to the mapping system 1000 (FIG. 10), below. In some embodiments, the segment based refinement module 410 is implemented using a same processor as the registration module 105, the change detection module 110, the segmentation module 405 and the downstream task module 135. In some embodiments, the segment based refinement module 410 is implemented using a different processor from the registration module 105, the change detection module 110, the segmentation module 405, or the downstream task module 135.

Utilizing the mapping system 400, the change 3D map 120 has a higher precision in comparison with other approaches due to the change determination being performed for entire objects. The inclusion of segmentation analysis in the mapping system 400 helps to further increase precision of object identification. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

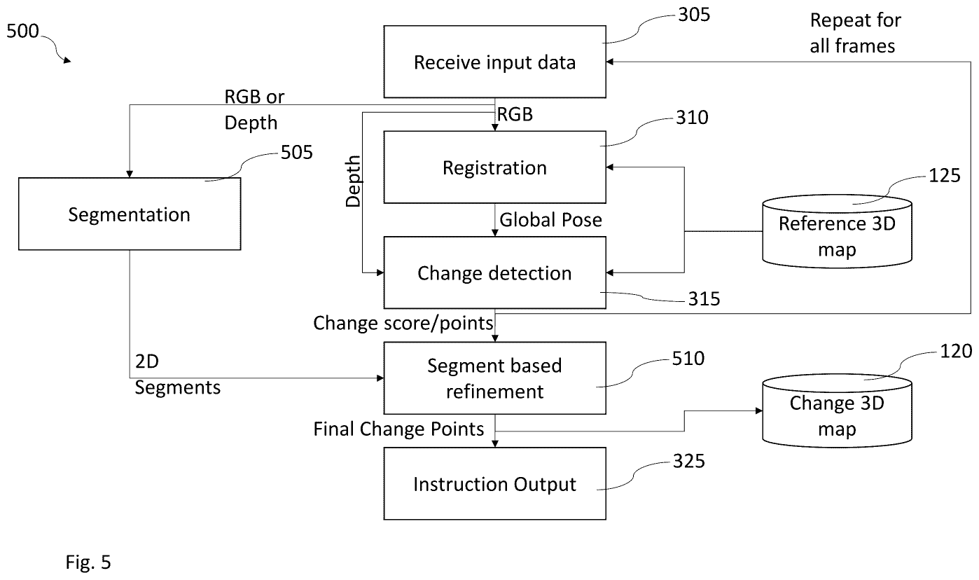

FIG. 5 is a flowchart of a method 500 of using a mapping system, in accordance with some embodiments. The method 500 is implemented by a mapping system to generate a change map and to generate instructions for a downstream implementation. In some embodiments, the method 500 is implemented using the mapping system 400 (FIG. 4). In some embodiments, the method 500 is implemented using a mapping system other than the mapping system 400 (FIG. 4). The method 500 includes similar elements as the method 300 (FIG. 3). Elements having the same reference number in the method 500 are similar as elements having the corresponding reference number in the method 300 (FIG. 3). Discussion of the elements having the same reference number is truncated for the sake of brevity.

In comparison with the method 300 (FIG. 3), the method 500 includes an operation 505 for performing segmentation of the input data and generating 2D segments. The method 500 also includes an operation 510 for performing change refinement based on change points and change scores as well as the 2D segments in order to help improve precision of object identification.

In operation 505, segmentation is performed on the input signal. The segmentation is performed utilizing only depth date or both image data and depth data. The segmentation helps to identify boundaries of potential objects within the scene to assist with change determination. The segmentation utilizes an algorithm to classify pixels in the input signal to help identify boundaries of objects within the scene. In some embodiments, the segmentation utilizes a k-means clustering algorithm, FCM algorithm, or another suitable algorithm. The segmentation identifies the boundaries of the objects and outputs 2D segments that are usable for segment based refinement to improve accuracy of change determination within the scene. The 2D segments include boundaries of objects identified during the segmentation.

In some embodiments, the operation 505 is implemented using the segmentation module 405 (FIG. 4) of the mapping system 400 (FIG. 4). In some embodiments, the operation 505 is implemented using a device other than the segmentation module 405 (FIG. 4). The segmentation helps to improve object identification in the method 500 in comparison with other approaches that do not include segmentation. However, the segmentation increases a processing load to implement the method 500 in comparison with other approaches that do not include segmentation.

In operation 510, segment based refinement is performed to identify geometrically meaningful objects within the scene to help determine changes within the scene. The segment based refinement is performed using the 2D segments from the operation 505 in addition to change points and change scores from the operation 315. The segment based refinement functions in a similar manner to the change refinement of operation 320 (FIG. 3), discussed above. Similar to the change refinement of operation 320 (FIG. 3), the segment based refinement of operation 510 analyzes the received data to identify geometrically meaningful objects within the scene for determination of changes within the scene. In comparison with the change refinement of operation 320 (FIG. 3), the segment based refinement of operation 510 is able to compare the change points and change scores with the 2D segments in order to improve the accuracy of change determination. The 2D segments would provide data related to the determined location of the boundaries of potential objects in order to assist in the determination of whether the object is a geometrically meaningful object usable to indicate a change in the scene. The segment based refinement outputs final change points to the change 3D map 120 following determination of whether one or more change is present in the scene based on the input signal. In some embodiments, the operation 510 is implemented using the segment based refinement module 410 (FIG. 4) of the mapping system 400 (FIG. 4). In some embodiments, the operation 510 is implemented using a device other than the segment based refinement module 410 (FIG. 4).

One of ordinary skill in the art would recognize that the method 500 is capable of being adjusted. In some embodiments, at least one operation is added to the method 500. For example, in some embodiments, the method 500 further includes an updated map generating operation. In some embodiments, at least one operation is omitted from the method 500. For example, in some embodiments, the operation 325 is omitted and the change 3D map 120 is stored on the non-transitory computer readable medium for use by a separate method. In some embodiments, an order of operations of the method 500 is adjusted. For example, in some embodiments, the operation 505 is performed prior to the operation 315 and the change detection is performed based on 2D segments output from operation 505.

Utilizing the method 500, the change 3D map 120 has a higher precision in comparison with other approaches due to the change determination being performed for entire objects. The inclusion of segmentation analysis in the mapping system 400 helps to further increase precision of object identification. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

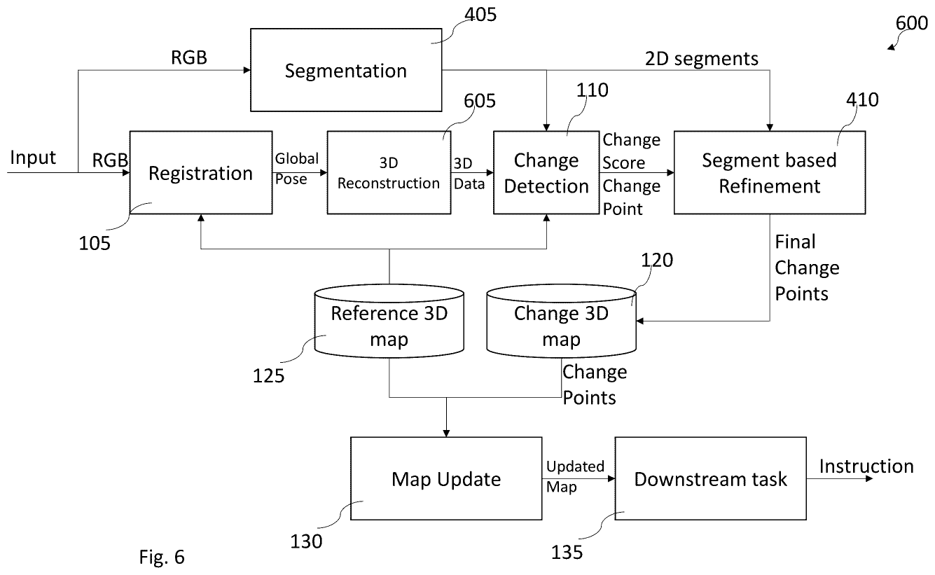

FIG. 6 is a schematic view of a mapping system 600, in accordance with some embodiments. The mapping system 600 includes similar elements as the mapping system 400 (FIG. 4). Elements having the same reference number in the mapping system 600 are similar as elements having the corresponding reference number in the mapping system 400 (FIG. 4). Discussion of the elements having the same reference number is truncated for the sake of brevity.

In comparison with the mapping system 400 (FIG. 4), the mapping system 600 is configured to receive an input signal that lacks depth data. As a result, the mapping system 600 includes a 3D reconstruction module 605 configured to receive the global pose from the registration module 105 and to generate 3D map data usable by the change detection module 110 to generate change points and change scores.

The 3D reconstruction module 605 is configured to receive the image data and the global pose in order to generate 3D map data. In some embodiments, the 3D map data has increased accuracy when multiple sensors are used to generate the input signal. Based on the known position of the sensor, through the global pose, the 3D reconstruction module 605 is able to determine relative distances between objects in the image data. Based on these relative distances, the 3D reconstruction module 605 is able to generate 3D map data usable by the change detection module 110.

The 3D reconstruction module 605 helps to implement scene mapping using lower cost sensors that lack depth data collection. This allows the utilization of the mapping system 600 in a wider variety of situations. The 3D reconstruction module 605 is implemented using one or more processors, such as the processor discussed with respect to the mapping system 1000 (FIG. 10), below. In some embodiments, the 3D reconstruction module 605 is implemented using a same processor as the registration module 105, the change detection module 110, the segmentation module 405, the segment based refinement module 410 and the downstream task module 135. In some embodiments, the 3D reconstruction module 605 is implemented using a different processor from the registration module 105, the change detection module 110, the segmentation module 405, the segment based refinement module 410, or the downstream task module 135.

In some embodiments, the change detection module 110 utilizing the 3D map data utilizes a point to point distance thresholding technique to compensate for imprecisions in the reconstruction of the 3D map data. The point to point thresholding technique helps to reduce a risk of false positives when determining change points and change scores since the input signal did not include depth data.

In some embodiments, the segmentation module 405 is omitted from the mapping system 600. In some embodiments where the segmentation module 405 is omitted, the mapping system utilizes change refinement module 115 (FIG. 1) in place of segment based refinement module 410.

Utilizing the mapping system 600, the change 3D map 120 has a higher precision in comparison with other approaches due to the change determination being performed for entire objects. The inclusion of the 3D reconstructions helps with use of the mapping system 600 in situations where a sensor capable of capturing depth data is not available. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

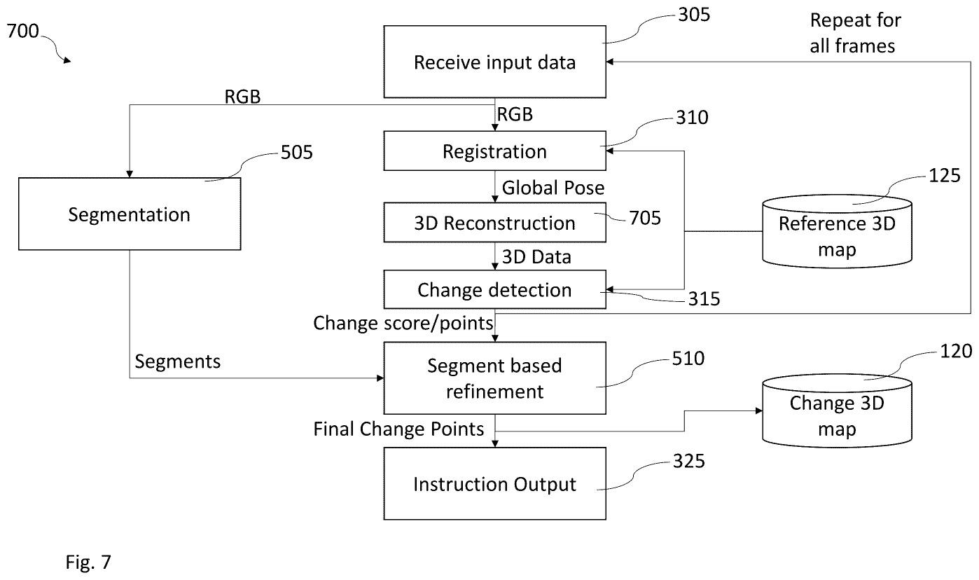

FIG. 7 is a flowchart of a method 700 of using a mapping system, in accordance with some embodiments. The method 700 is implemented by a mapping system to generate a change map and to generate instructions for a downstream implementation. In some embodiments, the method 700 is implemented using the mapping system 600 (FIG. 6). In some embodiments, the method 700 is implemented using a mapping system other than the mapping system 600 (FIG. 6). The method 700 includes similar elements as the method 500 (FIG. 5). Elements having the same reference number in the method 700 are similar as elements having the corresponding reference number in the method 500 (FIG. 5). Discussion of the elements having the same reference number is truncated for the sake of brevity.

In comparison with the method 500 (FIG. 5), the method 700 includes an operation 705 for performing 3D reconstruction of image data. In operation 705, 3D map data is reconstructed based on the image data and the global pose determined in operation 310. In some embodiments, the 3D map data has increased accuracy when multiple sensors are used to generate the input signal. Based on the known position of the sensor, through the global pose from operation 310 a determination is made regarding relative distances between objects in the image data. Based on these relative distances, 3D map is generated for determining changes in the scene.

In some embodiments, the operation 505 for performing segmentation is omitted from the method 700. In some embodiments where the operation 505 is omitted, the method 700 utilizes operation 320 (FIG. 3) in place of the operation 510.

One of ordinary skill in the art would recognize that the method 700 is capable of being adjusted. In some embodiments, at least one operation is added to the method 700. For example, in some embodiments, the method 700 further includes an updated map generating operation. In some embodiments, at least one operation is omitted from the method 700. For example, in some embodiments, the operation 325 is omitted and the change 3D map 120 is stored on the non-transitory computer readable medium for use by a separate method. In some embodiments, an order of operations of the method 700 is adjusted. For example, in some embodiments, the operation 505 is performed prior to the operation 315 and the change detection is performed based on 2D segments output from operation 505.

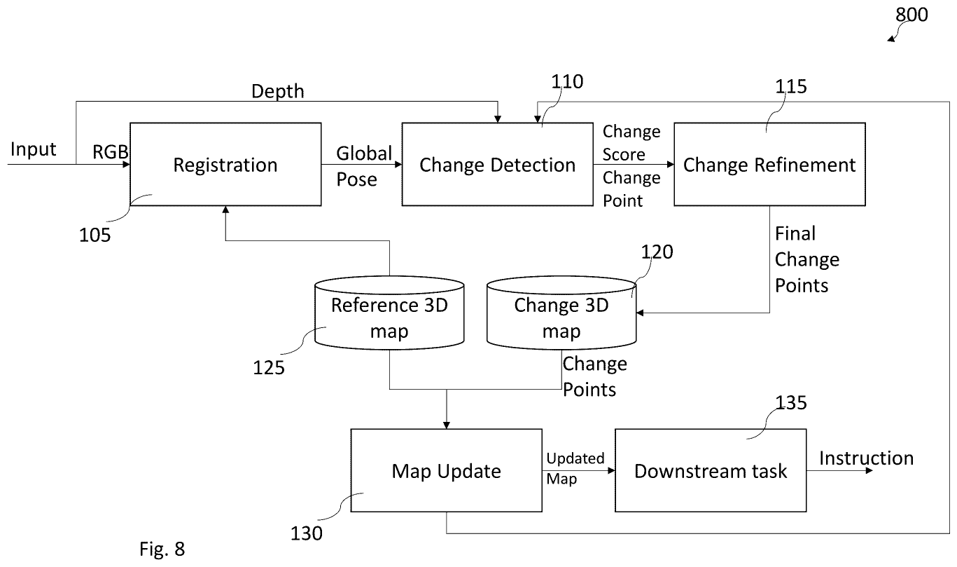

Utilizing the method 700, the change 3D map 120 has a higher precision in comparison with other approaches due to the change determination being performed for entire objects. The inclusion of 3D reconstructions permits the method 700 to be used in situation where a sensor capable of capturing depth data is not available. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems. FIG. 8 is a schematic view of a mapping system 800, in accordance with some embodiments. The mapping system 800 includes similar elements as the mapping system 100 (FIG. 1). Elements having the same reference number in the mapping system 800 are similar as elements having the corresponding reference number in the mapping system 100 (FIG. 1). Discussion of the elements having the same reference number is truncated for the sake of brevity.

In comparison with the mapping system 100 (FIG. 1), the mapping system 800 is configured to provide the updated map generated by the map update module 130 to the change detection module 110. By feeding the updated map into the change detection module 110, the mapping system 800 is capable of accounting for temporary objects within the scene. For example, if an object is not present during the generation of the reference 3D map 125, then the object is added at a later time and detected by the change detection module 110 the object will be identified as a change. If, subsequent to the detection of the object, the object is removed during a subsequent mapping of the scene, then a comparison between the reference 3D map and the input signal (following removal of the object) would indicate no change. As a result, change points would not be generate and a risk of failing to remove the object when the updated map is generated increases. By feeding the updated map back into the change detection module 110, the change detection module 110 is able to generate change points and change scores based on a more recent map.

In some embodiments, the feeding back of the update map is determined based on a query to the change 3D map 120 from a previous mapping of the scene. In response to a determination that the change 3D map 120 is empty, i.e., there are no changes from the reference 3D map, then the updated map is not fed back to the change detection module 110; and the change detection module 110 generates change points and changes scores based on comparisons with the reference 3D map 125. In response to a determination that the change 3D map 120 includes at least one change, then the updated map is fed back to the change detection module 110.

One of ordinary skill in the art would recognize that the feeding back of the updated map from the map update module 130 into the change detection module 110 is also usable in the mapping system 400 (FIG. 4) and the mapping system 600 (FIG. 6).

Utilizing the mapping system 800, the change 3D map 120 has a higher precision in comparison with other approaches due to the change determination being performed for entire objects. The inclusion of the feedback of the updated map into the change detection module 110 helps to account for temporary objects within the scene. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

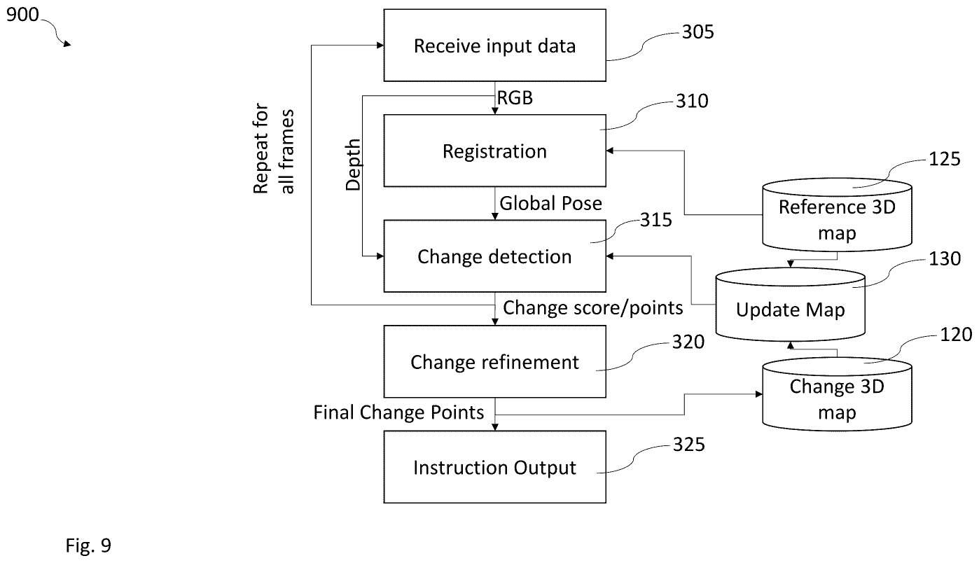

FIG. 9 is a flowchart of a method 900 of using a mapping system, in accordance with some embodiments. The method 900 is implemented by a mapping system to generate a change map and to generate instructions for a downstream implementation. In some embodiments, the method 900 is implemented using the mapping system 800 (FIG. 8). In some embodiments, the method 900 is implemented using a mapping system other than the mapping system 800 (FIG. 8). The method 900 includes similar elements as the method 300 (FIG. 3). Elements having the same reference number in the method 900 are similar as elements having the corresponding reference number in the method 300 (FIG. 3). Discussion of the elements having the same reference number is truncated for the sake of brevity.

In comparison with the method 300 (FIG. 3), the method 900 includes an update map 130 generated based on a comparison of the reference 3D map 125 and the change 3D map 120. The update map 130 is used for the operation 315 in order to help account for temporary objects in the scene.

In some embodiments, the use of the update map 130 in the operation 315 is determined based on a query to the change 3D map 120 from a previous mapping of the scene. In response to a determination that the change 3D map 120 is empty, i.e., there are no changes from the reference 3D map, then the updated map is not used in the operation 315; and operation 315 relies on the reference 3D map 125 instead. In response to a determination that the change 3D map 120 includes at least one change, then the updated map is used in the operation 315.

One of ordinary skill in the art would recognize that the feeding back of the updated map 130 into the operation 315 is also usable in the method 500 (FIG. 5) and the method 700 (FIG. 7).

One of ordinary skill in the art would recognize that the method 900 is capable of being adjusted. In some embodiments, at least one operation is added to the method 900. For example, in some embodiments, the method 900 further includes an updated map generating operation. In some embodiments, at least one operation is omitted from the method 900. For example, in some embodiments, use of the updated map 130 in the operation 315 is omitted if the change 3D map 120 from a previous scene mapping is empty. In some embodiments, an order of operations of the method 900 is adjusted. For example, in some embodiments, the operation 320 is included as part of the repeating operations for each of the frames.

Utilizing the method 900, the change 3D map 120 has a higher precision in comparison with other approaches due to the change determination being performed for entire objects. The use of the updated map 130 helps the method 900 to account for temporary objects within the scene. In addition, maintaining the reference 3D map 125 in an original state during the mapping of the scene helps to reduce or prevent propagation of errors through multiple scene mapping iterations. As a result, instructions provided to external devices based on the change 3D map 120 are more precise than instructions using maps generated using other systems.

FIG. 10 is a block diagram of a mapping system 1000, in accordance with some embodiments. Mapping system 1000 includes a hardware processor 1002 and a non-transitory, computer readable storage medium 1004 encoded with, i.e., storing, the computer program code 1006, i.e., a set of executable instructions. Computer readable storage medium 1004 is also encoded with instructions 1007 for interfacing with external devices. The processor 1002 is electrically coupled to the computer readable storage medium 1004 via a bus 1008. The processor 1002 is also electrically coupled to an input/output (I/O) interface 1010 by bus 1008. A network interface 1012 is also electrically connected to the processor 1002 via bus 1008. Network interface 1021 is connected to a network 1014, so that processor 1002 and computer readable storage medium 1004 are capable of connecting to external elements via network 1014. The processor 1002 is configured to execute the computer program code 1006 encoded in the computer readable storage medium 1004 in order to cause the mapping system 1000 to be usable for performing a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9).

In some embodiments, the processor 1002 is a central processing unit (CPU), a multi-processor, a distributed processing system, an application specific integrated circuit (ASIC), and/or a suitable processing unit.

In some embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1004 includes a compact disk-read only memory (CD-ROM), a compact disk-read/write (CD-R/W), and/or a digital video disc (DVD).

In some embodiments, the storage medium 1004 stores the computer program code 1006 configured to cause mapping system 1000 to perform a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9). In some embodiments, the storage medium 1004 also stores information used for performing a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9) as well as information generated during performing a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9), such as a depth parameter 1016, an image parameter 1018, a reference map parameter 1020, a change map parameter 1022, an update map parameter 1024 and/or a set of executable instructions to perform a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9).

In some embodiments, the storage medium 1004 stores instructions 1007 for interfacing with external devices. The instructions 1007 enable processor 1002 to generate instructions readable by the external devices to effectively implement a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9).

Mapping system 1000 includes I/O interface 1010. I/O interface 1010 is coupled to external circuitry. In some embodiments, I/O interface 1010 includes a keyboard, keypad, mouse, trackball, trackpad, and/or cursor direction keys for communicating information and commands to processor 1002.

Mapping system 1000 also includes network interface 1012 coupled to the processor 1002. Network interface 1012 allows mapping system 1000 to communicate with network 1014, to which one or more other computer systems are connected. Network interface 1012 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in mapping system 100 (FIG. 1), mapping system 200 (FIG. 2), method 300 (FIG. 3), mapping system 400 (FIG. 4), method 500 (FIG. 5), mapping system 600 (FIG. 6), method 700 (FIG. 7), mapping system 800 (FIG. 8), or method 900 (FIG. 9) is implemented in two or more mapping systems 1000, and information such as depth parameter 1016, image parameter 1018, reference map parameter 1020, change map parameter 1022, or update map parameter 1024 are exchanged between different mapping systems 1000 via network 1014.

### Supplemental Note 1

A mapping system includes a non-transitory computer readable medium configured to store instructions thereon. The mapping system further includes a processor connected to the non-transitory computer readable medium. The processor is configured to execute the instructions for receiving an input signal comprising image data of a scene. The processor is configured to execute the instructions for determining a position of a sensor used to capture the image data relative to a reference map of the scene. The processor is configured to execute the instructions for determining a change point and a change score for the scene based on the determined position of the sensor and the reference map. The processor is configured to execute the instructions for generating a change map based on the change point and the change score. The processor is configured to execute the instructions for generating an update map based on a comparison between the change map and the reference map. The processor is configured to execute the instructions for maintaining a content of the reference map unchanged.

### Supplemental Note 2

The mapping system of Supplemental Note 1, wherein the processor is further configured to execute the instructions for generating the change map by utilizing the change point and the change score to determine whether the change point and the change score indicate a geometrically meaningful shape within the image data.

### Supplemental Note 3

The mapping system of Supplemental Note 1 or 2, wherein the processor is further configured to execute the instructions for generating the change map indicating no change related to the point relative to the reference map in response to the change point and the change score failing to indicate the geometrically meaningful shape.

### Supplemental Note 4

The mapping system of any of Supplemental Notes 1-3, wherein the processor is further configured to execute the instructions for: generating the change map indicating a change related to the point relative to the reference map in response to the change point and the change score indicating the geometrically meaningful shape.

### Supplemental Note 5

The mapping system of any of Supplemental Notes 1-4, wherein the processor is further configured to execute the instructions for: receiving the input signal including depth data.

### Supplemental Note 6

The mapping system of any of Supplemental Notes 1-5, wherein the processor is further configured to execute the instructions for: segmenting the input signal to generate two-dimensional (2D) segments; and generating the change map utilizing the 2D segments.

### Supplemental Notes 7

The mapping system of Supplemental Notes 1-6, wherein the processor is further configured to execute the instructions for: reconstructing three-dimensional (3D) data based on the input signal; and determining the change point and the change score based on the reconstructed 3D data.

### Supplemental Note 8

A method of using a mapping system includes receiving an input signal comprising image data of a scene. The method includes determining a position of a sensor used to capture the image data relative to a reference map of the scene. The method includes determining a change point and a change score for the scene based on the determined position of the sensor and the reference map. The method includes generating a change map based on the change point and the change score. The method includes generating an update map based on a comparison between the change map and the reference map. The method includes maintaining a content of the reference map unchanged.

### Supplemental Note 9

The method of Supplemental Note 8, wherein generating the change map comprises utilizing the change point and the change score to determine whether the change point and the change score indicate a geometrically meaningful shape within the image data.

### Supplemental Note 10

The method of Supplemental Note 8 or 9, wherein generating the change map comprises indicating no change related to the point relative to the reference map in response to the change point and the change score failing to indicate the geometrically meaningful shape.

### Supplemental Note 11

The method of any of Supplemental Notes 8-10, wherein generating the change map comprises indicating a change related to the point relative to the reference map in response to the change point and the change score indicating the geometrically meaningful shape.

### Supplemental Note 12

The method of any of Supplemental Notes 8-11, wherein receiving the input signal comprises receiving depth data.

### Supplemental Note 13

The method of any of Supplemental Notes 8-12, further comprising: segmenting the input signal to generate two-dimensional (2D) segments; and generating the change map utilizing the 2D segments.

### Supplemental Note 14

The method of any of Supplemental Notes 8-13, further comprising: reconstructing three-dimensional (3D) data based on the input signal; and determining the change point and the change score based on the reconstructed 3D data.

### Supplemental Note 15

A non-transitory computer readable medium configured to store instructions thereon. The instructions are configured to cause a processor to receive an input signal comprising image data of a scene. The instructions are configured to cause a processor to determine a position of a sensor used to capture the image data relative to a reference map of the scene. The instructions are configured to cause a processor to determine a change point and a change score for the scene based on the determined position of the sensor and the reference map. The instructions are configured to cause a processor to generate a change map based on the change point and the change score. The instructions are configured to cause a processor to generate an update map based on a comparison between the change map and the reference map. The instructions are configured to cause a processor to maintain a content of the reference map unchanged.

### Supplemental Note 16

The non-transitory computer readable medium of Supplemental Note 15, wherein the instructions are configured to cause the processor to generate the change map utilizing the change point and the change score to determine whether the change point and the change score indicate a geometrically meaningful shape within the image data.

### Supplemental Note 17

The non-transitory computer readable medium of Supplemental Note 15 or 16, wherein the instructions are configured to cause the processor to generate the change map indicating no change related to the point relative to the reference map in response to the change point and the change score failing to indicate the geometrically meaningful shape.

### Supplemental Note 18

The non-transitory computer readable medium of any of Supplemental Notes 15-17, wherein the instructions are configured to cause the processor to generate the change map indicating a change related to the point relative to the reference map in response to the change point and the change score indicating the geometrically meaningful shape.

### Supplemental Note 19

The non-transitory computer readable medium of any of Supplemental Notes 15-18, wherein the instructions are configured to cause the processor to: segment the input signal to generate two-dimensional (2D) segments; and generate the change map utilizing the 2D segments.

### Supplemental Note 20

The non-transitory computer readable medium of any of Supplemental Notes 15-19, wherein the instructions are configured to cause the processor to: reconstruct three-dimensional (3D) data based on the input signal; and determine the change point and the change score based on the reconstructed 3D data.

### Supplemental Note 21

A mapping system includes a non-transitory computer readable medium configured to store instructions thereon. The mapping system includes a processor connected to the non-transitory computer readable medium. The processor is configured to execute the instructions for receiving an input signal comprising image data of a scene. The processor is configured to execute the instructions for determining a position of a sensor used to capture the image data relative to a reference map of the scene. The processor is configured to execute the instructions for determining a change point and a change score for the scene based on the determined position of the sensor, the reference map, and a first change map from a previous mapping of the scene. The processor is configured to execute the instructions for generating a second change map based on the change point and the change score. The processor is configured to execute the instructions for generating an update map based on a comparison between the second change map and the reference map. The processor is configured to execute the instructions for maintaining a content of the reference map unchanged.

### Supplemental Note 22

A mapping system includes a non-transitory computer readable medium configured to store instructions thereon. The mapping system includes a processor connected to the non-transitory computer readable medium. The processor is configured to execute the instructions for receiving an input signal of a scene, wherein the input signal comprises image data and depth data. The processor is configured to execute the instructions for determining a position of a sensor used to capture the image data relative to a reference map of the scene based on the image data. The processor is configured to execute the instructions for determining a change point and a change score for the scene based on the depth data, the determined position of the sensor, and the reference map. The processor is configured to execute the instructions for determining whether the object is a geometrically meaningful object based on the change point and the change score. The processor is configured to execute the instructions for generating an updated map in response to determining the object as the geometrically meaningful object. The processor is configured to execute the instructions for indicating no change relative to the reference map in response to a determination that the object is not the geometrically meaningful object.

### Supplemental Note 23

A mapping system includes a non-transitory computer readable medium configured to store instructions thereon. The mapping system further includes a processor connected to the non-transitory computer readable medium. The processor is configured to execute the instructions for receiving an input signal comprising image data of a scene. The processor is configured to execute the instructions for determining a position of a sensor used to capture the image data relative to a reference map of the scene. The processor is configured to execute the instructions for segmenting the image data to generate two-dimensional (2D) segments. The processor is configured to execute the instructions for determining a change point and a change score for the scene based on the determined position of the sensor and the reference map. The processor is configured to execute the instructions for generating a change map based on the change point and the change score and the 2D segments. The processor is configured to execute the instructions for generating an update map based on a comparison between the change map and the reference map. The processor is configured to execute the instructions for maintaining a content of the reference map unchanged.

### Supplemental Note 24

A mapping system includes a non-transitory computer readable medium configured to store instructions thereon. The mapping system includes a processor connected to the non-transitory computer readable medium. The processor is configured to execute the instructions for generating a reference map based on data from a first sensor, wherein the first sensor has a first resolution. The processor is configured to execute the instructions for receiving an input signal comprising image data of a scene. The processor is configured to execute the instructions for determining a position of a second sensor used to capture the image data relative to the reference map of the scene, wherein the second sensor has a second resolution less than the first resolution. The processor is configured to execute the instructions for determining a change point and a change score for the scene based on the determined position of the sensor and the reference map. The processor is configured to execute the instructions for generating a change map based on the change point and the change score. The processor is configured to execute the instructions for generating an update map based on a comparison between the change map and the reference map. The processor is configured to execute the instructions for maintaining a content of the reference map unchanged.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A mapping system comprising:
a non-transitory computer readable medium configured to store instructions thereon; and
a processor connected to the non-transitory computer readable medium, wherein the processor is configured to execute the instructions for:
receiving an input signal comprising image data of a scene;
determining a position of a sensor used to capture the image data relative to a reference map of the scene;
determining a change point and a change score for the scene based on the determined position of the sensor and the reference map;
generating a change map based on the change point and the change score;
generating an update map based on a comparison between the change map and the reference map; and
maintaining a content of the reference map unchanged.

2. The mapping system of claim 1, wherein the processor is further configured to execute the instructions for:
generating the change map by utilizing the change point and the change score to determine whether the change point and the change score indicate a geometrically meaningful shape within the image data.

3. The mapping system of claim 2, wherein the processor is further configured to execute the instructions for:
generating the change map indicating no change related to the point with respect to the reference map in response to the change point and the change score failing to indicate the geometrically meaningful shape.

4. The mapping system of claim 2, wherein the processor is further configured to execute the instructions for:
generating the change map indicating a change related to the point with respect to the reference map in response to the change point and the change score indicating the geometrically meaningful shape.

5. The mapping system of claim 1, wherein the processor is further configured to execute the instructions for:
receiving the input signal including depth data.

6. The mapping system of claim 1, wherein the processor is further configured to execute the instructions for:
segmenting the input signal to generate two-dimensional (2D) segments; and
generating the change map utilizing the 2D segments.

7. The mapping system of claim 1, wherein the processor is further configured to execute the instructions for:
reconstructing three-dimensional (3D) data based on the input signal; and
determining the change point and the change score based on the reconstructed 3D data.

8. A method of using a mapping system, the method comprising:
receiving an input signal comprising image data of a scene;
determining a position of a sensor used to capture the image data relative to a reference map of the scene;
determining a change point and a change score for the scene based on the determined position of the sensor and the reference map;
generating a change map based on the change point and the change score;
generating an update map based on a comparison between the change map and the reference map; and
maintaining a content of the reference map unchanged.

9. The method of claim 8, wherein generating the change map comprises utilizing the change point and the change score to determine whether the change point and the change score indicate a geometrically meaningful shape within the image data.

10. The method of claim 9, wherein generating the change map comprises indicating no change related to the point with respect to the reference map in response to the change point and the change score failing to indicate the geometrically meaningful shape.

11. The method of claim 9, wherein generating the change map comprises indicating a change related to the point with respect to the reference map in response to the change point and the change score indicating the geometrically meaningful shape.

12. The method of claim 8, wherein receiving the input signal comprises receiving depth data.

13. The method of claim 8, further comprising:
segmenting the input signal to generate two-dimensional (2D) segments; and
generating the change map utilizing the 2D segments.

14. The method of claim 8, further comprising:
reconstructing three-dimensional (3D) data based on the input signal; and
determining the change point and the change score based on the reconstructed 3D data.

15. A non-transitory computer readable medium configured to store instructions thereon, wherein the instructions are configured to cause a processor to:
receive an input signal comprising image data of a scene;
determine a position of a sensor used to capture the image data relative to a reference map of the scene;
determine a change point and a change score for the scene based on the determined position of the sensor and the reference map;
generate a change map based on the change point and the change score;
generate an update map based on a comparison between the change map and the reference map; and
maintain a content of the reference map unchanged.

16. The non-transitory computer readable medium of claim 15, wherein the instructions are configured to cause the processor to generate the change map utilizing the change point and the change score to determine whether the change point and the change score indicate a geometrically meaningful shape within the image data.

17. The non-transitory computer readable medium of claim 16, wherein the instructions are configured to cause the processor to generate the change map indicating no change related to the point with respect to the reference map in response to the change point and the change score failing to indicate the geometrically meaningful shape.

18. The non-transitory computer readable medium of claim 16, wherein the instructions are configured to cause the processor to generate the change map indicating a change related to the point with respect to the reference map in response to the change point and the change score indicating the geometrically meaningful shape.

19. The non-transitory computer readable medium of claim 8, wherein the instructions are configured to cause the processor to:
segment the input signal to generate two-dimensional (2D) segments; and
generate the change map utilizing the 2D segments.

20. The non-transitory computer readable medium of claim 8, wherein the instructions are configured to cause the processor to:
reconstruct three-dimensional (3D) data based on the input signal; and
determine the change point and the change score based on the reconstructed 3D data.
